(19) United States
(12) Patent Application Publication
(10) Pub. No.: US 2011/0184626 A1
(43) Pub. Date: Jul. 28, 2011

(54) METHOD AND DEVICE OF A CONTROL FOR A START- STOP CONTROL OPERATION OF AN INTERNAL COMBUSTION ENGINE

(76) Inventors: Ewald Mauritz, Weissach (DE); Karl-Otto Schmidt, Keltern (DE)

(21) Appl. No.: 12/737,656

(22) PCT Filed: Jun. 15, 2009
(86) PCT No.: PCT/EP2009/057391

§ 371 Date: Apr. 13, 2011

(30) Foreign Application Priority Data
Aug. 6, 2008 (DE) 102008041037.3

(51) Int. Cl. F02D 28/00

(52) U.S. Cl. 701/102

(57) ABSTRACT

In a method of control for a start-stop operation of an internal combustion engine in a motor vehicle for briefly stopping and starting the internal combustion engine, which is started by an electric machine as starter, a detection device detects the position and the rotational speed of a crankshaft following the switch-off of the internal combustion engine. The curve of the rotational speed of the crankshaft following the switch-off of the internal combustion engine is actively and instantaneously calculated in advance.

### BACKGROUND OF THE INVENTION

1. Field of the Invention

The present invention relates to a method of control for a start-stop operation of an internal combustion engine in a motor vehicle for briefly stopping and starting the internal combustion engine, which is started by an electric machine as starter, a detection device detecting the position and the rotational speed of a crankshaft during the operation and following the switch-off of the internal combustion engine, in particular in the event of a brief stop. The present invention further relates to a computer program product and a control having a microcomputer including a program memory.

2. Description of Related Art

In order to save fuel and emissions, it is known for an engine control to switch off the internal combustion engine in a vehicle according to particular switch-off conditions, in particular following a specific time lapse, for example at traffic lights or at other traffic impediments that necessitate a brief stop. Usually, the internal combustion engine is started by a starter, which has a starter pinion that is engaged into a ring gear of an internal combustion engine. For such a construction of an internal combustion engine, as is started with the aid of a starter pinion, there are minimum time periods for a restart, which must be awaited before the internal combustion engine may be started again.

There are developments to engage the starter pinion into the ring gear already while the internal combustion engine is running down and to shorten the starting time. The following related art is known in this connection.

Published German patent application document DE 10 2006 011 644 A1 describes a device and a method for operating a device having a starter pinion and a ring gear of an internal combustion engine, the rotational speed of the ring gear and of the starter pinion being ascertained in order, following the switch-off of the internal combustion engine, to engage the starter pinion at the essentially identical rotational speed as the internal combustion engine is running down. In order to ascertain the synchronous engagement speeds, values are assigned from a characteristics map of a control unit.

Published German patent application document DE 10 2006 039 112 A1 describes a method for determining the rotational speed of the starter for an internal combustion engine of a motor vehicle. Furthermore, there is the description that the starter comprises a starter control unit of its own to calculate the rotational speed of the starter and in order to accelerate the pinion of the starter initially without engagement in a start-stop operation if a self-start of the internal combustion engine is no longer possible due to the reduced rotational speed. The pinion is engaged at a synchronous rotational speed into the ring gear of the internal combustion engine as the latter is running down.

Published German patent application document DE 10 2005 004 326 describes a starting device for an internal combustion engine having a separate engaging and starting process. For this purpose, the starting device has a control unit, which separately controls a starter motor and an actuator for engaging a starter pinion. The control unit is able to engage the pinion into the ring gear prior to a starting process of the vehicle, before the driver has issued a new starting request. For this purpose, the actuator is triggered as an engaging relay already during a run-down phase of the internal combustion engine. The rotational speed threshold here is far below the idling speed of the engine so as to minimize the wear of the engaging device. In order to avoid voltage drops in the vehicle electrical system by a very high starting current of the starter motor, the control achieves a gentle start, for example by clocking the starter current. The performance of the vehicle electrical system is monitored by analyzing the state of the battery, and the starter motor is clocked or supplied with current accordingly. Furthermore, the present invention describes that the crankshaft may be positioned shortly before or after the internal combustion engine comes to a standstill so as to shorten the starting time.

Published German patent application document DE 10 2005 021 227 A1 describes a starting device for an internal combustion engine in motor vehicles having a control unit, a starter relay, a starter pinion, and a starter motor for a start-stop operating strategy.

### BRIEF SUMMARY OF THE INVENTION

It is an objective of the present invention to develop a method, a computer program product, and a start-stop control of the kind mentioned at the outset in such a way that a vehicle comfort is improved in that a restart of the internal combustion engine may be performed considerably more quickly.

An underlying idea of the present invention is that the speed curve of a crankshaft when switching off the internal combustion engine is extremely inhomogeneous and that therefore a rough averaging results in a rough braking deceleration value, which is disadvantageous for engaging a starter pinion of a starter into a ring gear of an internal combustion engine due to a great tolerance band. For this reason, according to one idea of the present invention, the rotational speed curve of a falling rotational speed of the crankshaft is respectively calculated in an instantaneous, individual and specific manner.

The objective is achieved in terms of a method in that the curve of the rotational speed of the crankshaft following the switch-off of the internal combustion engine is actively and newly calculated in advance. It is thus possible to calculate in advance highly precise information regarding the rotational speed of a ring gear since current environmental conditions such as temperature and current friction and brake torques enter into the measuring result and the calculation. The term “actively” is thus to be understood as an instantaneous calculation from new measured values, without looking up and deriving predictive values from previously stored characteristic curves.

According to one specific embodiment developing the present invention, the angular speed of the crankshaft of the internal combustion engine is detected at characteristic, in particular recurring, positions of the crankshaft, while the internal combustion engine is running down, and is calculated. This has the advantage that the data quantities to be measured and analyzed are very small in comparison to an analysis of the entire inhomogeneous speed curve with rough averaging. At the same time, advantageously, the external conditions, which influence the angular speed or the angular speed gradient, for example the engine temperature, the engine oil quality, the age of the engine, internal friction torques and additional braking torques by accessories etc., are instantaneously detected. This makes it possible to achieve a very specific and substantially more precise prediction for the curve of the rotational speed of the crankshaft than is conventionally known. Hitherto it is known to query values from characteristic curves, which with rough averaging are for example stored in the control.

According to one specific embodiment developing the present invention, the angular speed of the crankshaft is detected in ignitable top dead centers and calculated. The method according to the present invention advantageously makes use of. the fact that the ignitable top dead centers of an internal combustion engine reflect characteristic rotational speed runs, at which the angular speed is briefly somewhat slower than in the other positions. Thus the top dead centers (ITDC) are able to provide reliable data in order instantaneously to determine a speed curve using a small data quantity and to make a prediction about the future angular speed of the crankshaft.

From at least two values of the angular speed of ignitable top dead centers (ITDC), at least one third value is preferably calculated for a subsequent, future ignitable top dead center (ITDC3). Thus it is possible to ascertain an angular speed gradient from a small number of values in order to calculate in advance the next characteristic value.

In order to include the influence of multiple cylinders in an internal combustion engine, an, in particular averaged, correction factor from energy losses of a decompression phase of a first cylinder and a compression phase of a second cylinder of the internal combustion engine is calculated and taken into account as an ignition sequence pair for calculating the angular speed in future top dead centers. The curve of the rotational speed may thus be taken into account as a function of the number of cylinders in the internal combustion engine as well as individual ignition sequence pairs in a prediction of the rotational speed of the crankshaft in the next milliseconds. The order of the ignition sequence pairs is fundamentally determined by the construction of the internal combustion engine. Thus recurring ignition sequence pairs may be taken into account very accurately in the calculation for future top dead centers.

According to the present invention, the rotational speed curve is detected at a very high speed with a scanning rate by a sensor device on the internal combustion engine, and the ascertained values are evaluated for predicting low rotational speeds shortly before standstill. This makes it possible to use cost-effectively a conventional sensor device on the crankshaft of the internal combustion engine, the scanning rate of which is typically limited to 50 to 100 signals per revolution. In order to produce imaginary interpolation points using the scanning rate already existing in the vehicle at slow speeds in the millisecond range, in addition to the few real detectable ones, from which the position and the rotational speed of the crankshaft is ascertained, values in a low speed range are inferred from measured values from a high speed range. Thus it is possible to derive a future angular speed.

According to another preferred method, the angular speed of the crankshaft is calculated in advance, from which a synchronous rotational speed for a running-up starter is determined, and afterwards a starter pinion of the starter is engaged, at an essentially synchronous rotational speed, into a ring gear of the internal combustion engine that is running down at a falling rotational speed. A synchronous engagement is to be understood as the rotational speed and the time at which the rotational speed of the starter pinion and the rotational speed of the ring gear of the internal combustion engine essentially coincide, i.e. when the window of a rotational speed difference of the starter pinion and the ring gear is sufficiently small. On the basis of the individual pre-calculation of the angular speed it is possible to determine an individual engagement time. A control developed for a start-stop operation brings the rotational speed of the starter pinion to the pre-calculated rotational speed of the internal combustion engine at a specific engagement time. A very accurate synchronous rotational speed of the starter pinion and the internal combustion engine is thus achieved. Wear is thus decreased and noise is reduced. The internal combustion engine may be restarted upon the time of engagement.

According to another preferred method, the angular speed of the crankshaft with the starter pinion engaged in the ring gear is calculated in advance, and the starter is briefly energized in a controlled manner as a function of an anticipated position of a standstill of the crankshaft that is calculated in advance, in order to prevent the crankshaft from swinging back and/or to move the crankshaft into a favorable engine type-specific preferred position, in particular at an angle greater than 60°, and especially preferably approx. 80° to 100° , very especially preferably of approx. 90°, before the next top ignitable dead center. The angular values are indicated here only by way of example for a 6 cylinder engine.

Thus the above-described method may be used a second time for a start-stop operation in order to bring the crankshaft into such an optimal angle in the internal combustion engine, at which the internal combustion engine may be started quickly.

The objective is also achieved by a computer program product, which is loadable into a program memory with program instructions, in order to perform all of the steps of the above-described method when executing the program in a control.

The computer program product requires no additional components in the vehicle, but may rather be implemented as a module in already existing controls in the vehicle. The computer program product may be provided for example in the engine control, a separate control, or a starter control. The computer program product has the additional advantage that it is readily adaptable to individual and particular customer requests, and that an improvement of the operating strategy by improved empirical values is possible or that individually provided values of the vehicle are readily usable.

The objective is also achieved by a control in that the microcomputer in the control is developed as a detection, evaluation, and control device, it being possible to load an above-described computer program product into the program memory in order to implement an above-described method. The control for a start-stop operation may be developed either in an engine control or in a separate control, for example in a starter control for controlling a starter or separately from other controls. Via a bus system, the control is in informational contact at least with the engine control.

In order to keep the informational paths as short as possible and thus achieve a low time loss, the control is developed in the engine control for example. To reduce a time loss likewise to a minimum and thus to achieve a quick triggering of the starter and for engaging the starter pinion, the control is alternatively advantageously accommodated in the starter control. Both alternatives have the advantage that essential parts of the hardware, which exist for example for other functions, may be used for implementing the method.

It is understood that the aforementioned features, which will be discussed below, are able to be used not only in the individually indicated combination, but also in other combinations.

### BRIEF DESCRIPTION OF THE DRAWINGS

FIG. 1 shows a schematic circuit diagram of drive components for implementing the method according to the present invention.

FIG. 2 shows a flow chart of the method according to the present invention.

FIG. 3 shows a time-rotational speed diagram at the end of the run-down of an internal combustion engine.

FIG. 4 a time-rotational speed diagram over a longer time period.

### DETAILED DESCRIPTION OF THE INVENTION

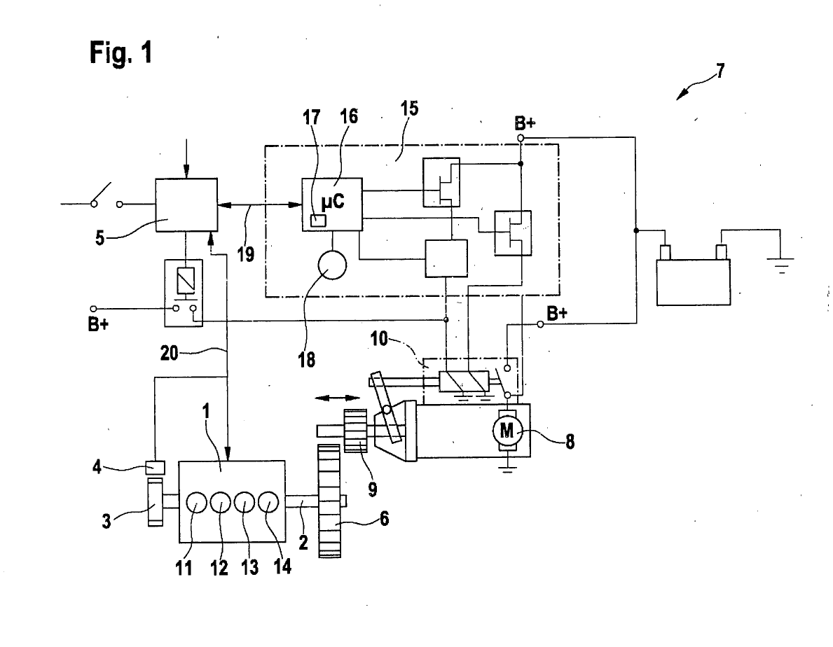

FIG. 1 shows a simplified circuit diagram of drive components for implementing a start-stop operating strategy. An internal combustion engine 1 is developed having multiple cylinders 11, 12, 13, 14. Pistons in cylinders 11 through 14 drive a crankshaft 2. For controlling internal combustion engine 1 correctly and for detecting the position of the pistons in cylinders 11 through 14, a gear wheel 3 is mounted on crankshaft 2, which typically has 50 to 100 teeth and gaps. In one place on gear wheel 3, a larger gap is developed as a synchronization mark. A sensor 4 detects the synchronization mark and the tooth-gap sequence and transmits these detected values to engine control 5.

To start internal combustion engine 1, a ring gear 6 is mounted on crankshaft 2 on the end opposite gear wheel 3. Ring gear 6 is turned by a starting device 7 when starting internal combustion engine 1. Starting device 7 comprises a starter 8, on the axle of which a starter pinion 9 is supported in an axially displaceable manner. Starter pinion 9 is able to be engaged and disengaged into ring gear 6 by a starter relay 10. In order to be able to perform a start-stop operation, starting device 7 has a starter control 15. Starter control 15 has a microcomputer 16 including a program memory 17. Using starter control 15, starter relay 10 and starter 8 may be controlled separately. Microcomputer 16 furthermore has a timer 18. Microcomputer 16 is in informational contact with engine control 5 via a bus system, for example via a CAN bus 19. For the purpose of exchanging information, engine control 5 is connected with actuators and sensors of internal combustion engine 1. Via a bus system 20, sensor 4 is in informational contact with engine control 5 in order to control the actuators on the basis of values from sensors.

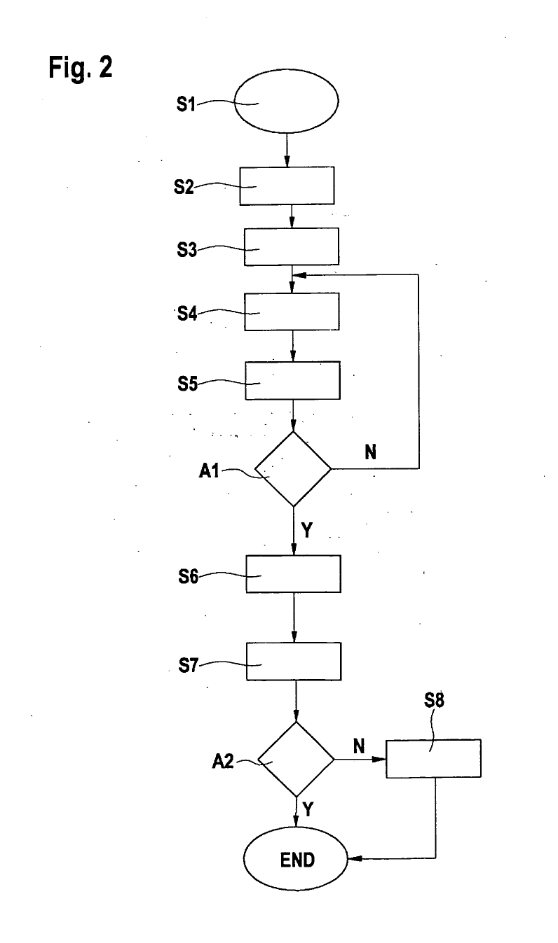

Microcomputer 16 implements the method described with reference to FIG. 2 in that engine control 5 transmits to it the crankshaft position and the angular speed of crankshaft 2.

FIG. 2 shows a flowchart of a particularly preferred method. In step S1, internal combustion engine 1 is started, after the crankshaft position and the rotational speed of crankshaft 2 were measured and communicated to engine control 5. The rotational speed n of crankshaft 2 and the position of crankshaft 2 are continuously measured by a sensor device comprising gear wheel 3 and sensor 4. This information is transmitted to engine control 5 for verification and correction.

In Step S3, engine control 5 receives a switch-off signal for a brief stop of internal combustion engine 1 on the basis of switch-off conditions, which are communicated either via the game bus system, a CAN bus 19, or via a separate bus system. The switch-off conditions result for example from the speed of the vehicle and/or a pedal position and/or gear selection of the vehicle.

Engine control 5 or another control provided for a start-stop operation selects an operating strategy, according to which internal combustion engine 1 and starting device 7 are controlled in a defined manner in order to be able to provide as quickly as possible an availability of internal combustion engine 1 in the event of a changing operating request of the driver.

Normally, the internal combustion engine is switched off based on a start-stop operating strategy after receiving a stop signal.

After being switched off, for example by stopping the fuel supply, internal combustion engine does not immediately come to a standstill, but rather runs down in a characteristic manner. In ignitable top dead centers ITDC in the individual cylinders 11 through 14, which are followed by a working cycle, an angular speed sets in, which characterizes the kinetic energy of the overall system at this time.

According to the present invention, in a step S4, the angular speed at these top dead centers ITDC is measured and the kinetic energy is calculated. According to one idea of the present invention, the angular speed, in comparison to the angular speeds that set in one cycle or multiple cycles earlier, yields an inference regarding the angular speeds to be expected in the next cycles.

The prediction of the speed and of the time for the next ITDC occurs according to the following method:

The angular speed ωₙ is determined in the range of predetermined characteristic positions of crankshaft 2, which correspond to the ignitable top dead centers (ITDCs). “n” stands for the n^{th} ITDC center. From two ascertained values during the run-down, the angular speed gradient is determined and thus the next angular speed and also the one for the subsequent ITDCs. This allows for a very accurate and very precise prediction, at what time in the millisecond range and at what speed the next ITDCs are traversed.

In a first approximation, the braking torque M_{braking}, acting against the direction of rotation while the engine is running down, is regarded as constant. The braking torque is made up, among other things, of internal friction torques, heat losses, flow losses and losses due to accessories that are driven along.

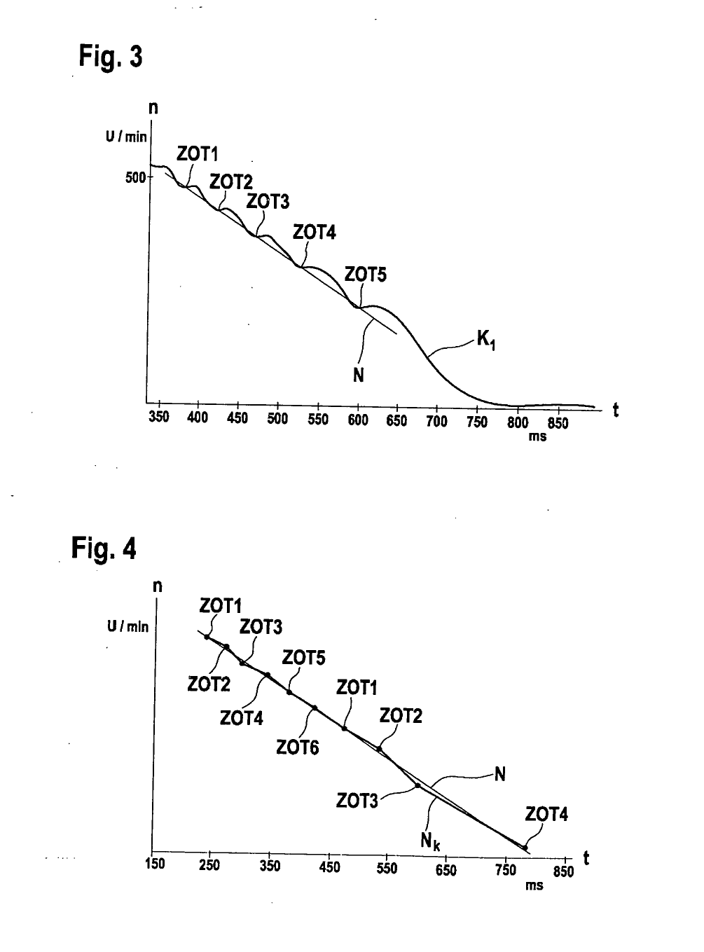

Thus a constant angular acceleration α_{braking} sets in. FIGS. 3 and 4 show the gradient by a linear drop of the rotational speed n of the internal combustion engine over time. It is thus assumed that

ω(t)=α_{braking}*t+ωₒ where α_{braking}=const.

For the n^{th} ITDC, the following then holds:

ωₙ=α^{braking}*tn+ωₒ

α_{braking}=(ωₙ₋₁−ωₙ)/(tₙ₋₁−tₙ)

By squaring ωₙ it is possible to produce a value that is proportional to the kinetic energy at this point in time. The proportionality constant K essentially corresponds to half of the moment of inertia J of the overall system.

Eᵣₒₜ=K*ω²=1/2*J*ω²

For the decline of the kinetic energy from ITDC to ITDC, the following then holds:

E_{braking ITDC to ITDC}=M_{braking}*φ=const ., since M_{braking}=const. and _{φITDC to ITDC}=const. (_{φITDC to ITDC} is a function of the number of cylinders).

E_{rot n}=E_{rot n-1}−E_{braking ITDC to ITDC} where energy equivalent E_{braking ITDC to ITDC}=K*_{braking ITDC to ITDC}² thus: ωₙ²=ωₙ₋₁²−ω_{braking ITDC to ITDC}²

Via this relationship, the following may be determined in two ITDC passes:

ω_{braking ITDC to ITDC}²=ωₙ₋₁²−ωₙ² and

α_{braking}=(ωₙ₋₁−ωₙ)/(tₙ₋₁−tₙ).

As a prediction of the time of the next ITDCs, the following holds in exemplary fashion:

tₙ₊₁=(ωₙ₊₁−ωₙ)/α_{braking}+tₙ

FIG. 4 shows the typical position of the ITDC values in a time-angular speed or rotational speed diagram for an internal combustion engine having 6 cylinders.

According to the above-described method, so far a constant speed gradient was assumed while the internal combustion engine is running down. In internal combustion engines having multiple cylinders,, deviations occur that can have very different causes. Possible factors are on the one hand that one cylinder differs from another in a different compression/decompression behavior and/or different heat and flow losses during the compression/decompression etc.

For this reason, in step S5, additionally a correction factor is calculated on the basis of multiple cylinders in the internal combustion engine and from this the next ITDCs are determined.

FIG. 4 shows the angular speeds without a correction factor for cylinder-to-cylinder deviations for a 6 cylinder engine by a thinly drawn straight line N. The correction factor comprises a cylinder-specific deviation, which is represented by the more thickly drawn characteristic curve Nₖ, in which the values for ITDC2 and ITDC4 are shown somewhat above and the values for ITDC3 respectively somewhat below the thinner straight line N.

The varying energy losses occurring from cylinder to cylinder have the result that the energy content differs from cylinder to cylinder, which is stored during the compression phase in the compressed air column and is then output as kinetic energy during the decompression phase. As a function of the cylinder currently in compression, an additional ignition sequence-specific correction factor is introduced. It takes into account the above-described deviations from cylinder to cylinder and thus results in a more accurate prediction for the time of the next pass through the ITDC and to an accurate prediction for the angular speed setting in in this ITDC.

The correction factor is composed of the losses during the last decompression phase and the losses of the next compression phase.

The ITDCs are to be run through in the sequence, as shown for example in FIG. 5, that is, ITDC1, ITDC2, ITDC3, ITDC4, ITDC5 . . . ITDCn.

Since the ignition sequence in an internal combustion engine is defined, there is only one set of relevant decompression/compression pairs, that is, an ignition sequence pair, which characterize the energy loss from ITDC to ITDC, namely, in the following pair set: (decompression 1/compression 2), (decompression 2/compression 3), (decompression 3/compression 4), (decompression 4/compression 5), . . . , (decompression n/compression n+1).

The following equation then applies:

E_{ITDC}_{—n+l}=Eᵣₒₜ_{—n+l}=E_{comp}_{—n+l}=Eᵣₒₜ _{—n+l}+E_{comp}_{—n}−Eₗₒₛₛ_{—pair (n/n+l)}

While the internal combustion engine is running down, the total torque acting against the direction of rotation, i.e. the braking torque, is regarded in a first approximation as constant. This is represented by the straight line N from FIGS. 3 and 4. The braking torque is made up of internal friction torques, heat losses, flow losses and losses due to accessories that are driven along.

In step S5, the typical, individual correction factor for each individual ignition sequence pair is taken into account for the internal combustion engine and for the current state of the internal combustion engine. The typical correction factor has either been newly calculated or it is a “learned” correction factor, which was averaged from speeds measured during a run-down of the internal combustion engine at the ITDC times over the time axis by a linearly falling line N. An analysis of the deviation of the individual speeds in the respective ITDCs with respect to the linearized curve yields the correction factor for the respective ignition sequence pair. In very brief run-downs of the internal combustion engine, it is possible to analyze and accordingly evaluate multiple successive run-downs of the internal combustion engine. An averaging over multiple correction factor determinations increases the accuracy of the correction.

That is to say, the angular speed gradient is evaluated for each individual run-down of the internal combustion engine. Thus, in contrast to the related art, no values from a stored characteristics map are utilized for predicting the next ITDCs since the speed curve is inhomogeneous and has a wide tolerance field such that no specific information may be ascertained.

Moreover, the method according to the present invention has the advantage that predictive values for the time and the angular speed in the next ITDC passes are independent of external conditions that possibly change suddenly or even such that change with a long time constant.

The data quantities to be measured and analyzed in steps S4 and S5 are small. In spite of the reduced measuring and calculations effort, it is possible to make a very specific and very accurate prediction for the future regarding the time of the subsequent ITDCs.

This results in a narrow tolerance band, within which the prediction is found. Among other things, this is due to the fact that the state of the internal combustion engine, as it presents itself at the time of the measurement and determination of correction predictions, is newly detected each time. This makes the prediction very accurate.

Thus, according to the present invention, a position-dependent speed measurement of the crankshaft is performed in order to make a prediction for the future.

If the control in step S5 has ascertained a specific pre-calculated time at which simultaneously at the same rotational speed starter pinion 9 may be engaged into ring gear 6, then a query is made in step Al as to whether this time has been reached. If this time has not yet been reached, the control repeats steps S4 and S5 and detects, calculates, and corrects the speed curve for the next ITDCs in the millisecond range. If the pre-calculated time has been reached, then the control checks whether on the basis of the most recent prediction and the current rotational speeds of the internal combustion engine and the expected rotational speed of the starter pinion a (fine) correction of the engagement time is performed. With this possibly corrected engagement time, the control method continues in step S6.

In step S6, starter pinion 9 is moved at a predetermined time by starter relay 10 in the axial direction on the axle of starter 8 and is engaged in ring gear 6. Depending on the operating strategy, starter 8 is started either prior to the switch-off, at the same time as the switch-off of internal combustion engine 1, or during the execution of steps S4 and S5, and is accelerated to a rotational speed n, which was determined by the control in step S5. Thus it is possible to engage starter pinion 9 in a very precise tolerance band at an approximately synchronous rotational speed. Starter pinion 9 remains engaged in ring gear 6 and runs down together with internal combustion engine 1, as long as no change in the operating strategy is provided or no change in the operating request is transmitted to engine control 5.

In step S7, the control checks, in accordance with the method described with reference to steps S4 and S5, at what position the crankshaft will come to a standstill.

A subsequent query A2 inquires whether crankshaft 2 comes to a standstill in an ideal position so as to be able to start internal combustion engine 1 as quickly as possible, i.e. whether crankshaft 2 at an ITDC for example stands at a favorable angle of approx. 90° before the next ITDC. If this is the case, the method ends in the control.

If query A2 detects an unfavorable crankshaft angle with respect to the next ITDC, or a swing-back is predicted, then starter 8 is energized in a defined manner in the range of milliseconds in step S8 such that crankshaft 2 is brought into a precisely defined position in order to be able to start internal combustion engine 1 as quickly as possible and from an ideal state. In this step S8, starter 8 functions together with starter control 8 as a servomotor or as an actuator. The position of the crankshaft is detected further and starter 8 is possibly energized once more briefly such that crankshaft 2 comes to a standstill at a specified angle with respect to the next ITDC. Subsequently, the method comes to an end. At the end, the system thus only awaits a start impulse from engine control 5 for starting internal combustion engine 1.

As already described with respect to FIG. 2 and steps S4 and S5, FIG. 3 shows a characteristic curve K₁ of crankshaft 2 with characteristic positions while an internal combustion engine 1 is running down after internal combustion engine 1 was switched off for example. At the so-called ITDCs (ITDC1, ITDC2, ITDC3, ITDC4, ITDC5), characteristic points result, at which the rotational speed curve initially falls more steeply as a result of the compression behavior prior to a working phase of the individual cylinders 11 through 14. In the ITDCs, the rotational speed curve has local minima or ranges having a flatter angular speed gradient, as a result of the speed increase during the decompression phase. Linear characteristic curve N represents the angular speed gradient over time t.

FIG. 4 shows the position of the ITDC values over a greater time period than FIG. 3, once without the correction of cylinder-to-cylinder deviations as characteristic curve N, and once as characteristic curve Nₖ, taking the above-described correction factor into account.

All the figures show only schematic illustrations which are not to scale. In other respects, reference is made especially to the drawings as being essential to the present invention.

1-10. (canceled)

11. A method of a start-stop control for an internal combustion engine in a motor vehicle, comprising:
switching off, using an engine control, the internal combustion engine if at least one predetermined switch-off condition is present;
after the switching off, detecting the position and the angular speed of a crankshaft using a detection device; and
calculating, using at least the detected angular speed of the crankshaft, a time-curve of the angular speed of the crankshaft over a predetermined time period following the switching off of the internal combustion engine.

12. The method as recited in claim 11, wherein the angular speed of the crankshaft of the internal combustion engine is detected at recurring characteristic positions of the crankshaft after the switching off.

13. The method as recited in claim 11, wherein the angular speed is detected at ignitable top dead centers of the crankshaft.

14. The method as recited in claim 13, wherein angular speed values corresponding to at least two ignitable top dead centers are detected, and at least one third angular speed value is calculated for a subsequent ignitable top dead center based on the detected angular speed values corresponding to the at least two ignitable top dead centers.

15. The method as recited in claim 14, further comprising:
calculating a correction factor from energy losses of a decompression phase of a first cylinder and a compression phase of a second cylinder of the internal combustion engine, wherein the calculated correction factor is taken into account in calculating the angular speed value corresponding to the subsequent ignitable top dead center.

16. The method as recited in claim 11, wherein the time-curve of the angular speed of the crankshaft is calculated based on detected first angular speed, and wherein the time-curve is used to predict a second angular speed of the crankshaft before the crankshaft reaches standstill, the second angular speed being lower than the first angular speed.

17. The method as recited in claim 16, wherein the calculated second angular speed of the crankshaft is used to control an electric machine of the motor vehicle used as a starter in such a way that a starter pinion of the electric machine is engaged into a ring gear of the internal combustion engine at substantially the same angular speed as the second angular speed.

18. The method as recited in claim 16, further comprising:
calculating an anticipated standstill position of the crankshaft, wherein the electric machine is briefly energized in a controlled manner as a function of the anticipated standstill position of the crankshaft in order to at least one of (i) prevent the crankshaft from swinging back and (ii) move the crankshaft into a predetermined position at an angle of approximately 90° before the next ignitable top dead center.

19. A non-transitory computer-readable data storage medium storing a computer program having program instructions which, when executed on a computer, performs a method of a start-stop control for an internal combustion engine in a motor vehicle, the method comprising:
switching off, using an engine control, the internal combustion engine if at least one predetermined switch-off condition is present;
after the switching off, detecting the position and the angular speed of a crankshaft using a detection device; and
calculating, using at least the detected angular speed of the crankshaft, a time-curve of the angular speed of the crankshaft over a predetermined time period following the switching off of the internal combustion engine.

20. A control device for a start-stop control for an internal combustion engine in a motor vehicle, comprising:
switching off, using an engine control, the internal combustion engine if at least one predetermined switch-off condition is present;
after the switching off, detecting the position and the angular speed of a crankshaft using a detection device; and
calculating, using at least the detected angular speed of the crankshaft, a time-curve of the angular speed of the crankshaft over a predetermined time period following the switching off of the internal combustion engine.
